(19) United States
(12) Patent Application Publication
(10) Pub. No.: US 2004/0260719 A1
(43) Pub. Date: Dec. 23, 2004

(54) Method with management of an opaque user identifier for checking complete delivery of a service using a set of servers

(76) Inventors: Christophe Giraud-Sauveur, Montbonnot Saint Martin (FR); Fabien Guinet, Pommiers La Placette (FR); Frederic Vignaud, Le Sappey En Chartreuse (FR)

Correspondence Address: PERMAN & GREEN, 425 POST ROAD, FAIRFIELD, CT, 06824, US

(21) Appl. No.: 10/823,904

(22) Filed: Apr. 14, 2004

(30) Foreign Application Priority Data
Jun. 6, 2003 (FR) FR 03 06898

(51) Int. Cl. G06F 17/00

(52) U.S. Cl. 707/102

(57) ABSTRACT

The process is done by means of a transactional identifier server storing a description of service offers taken out by the user from service providers, in a memory for each user. The transactional identifier server comprises a management module used to associate an opaque transactional identifier with a user and a service.

A request is sent to open a service calling one or several “enabler” server elements performing sub-transactions. This request, described sequentially and addressed to a communication interface of the transactional identifier server, notifies a user identification. The request is analysed and the transactional identifier server generates an opaque transactional identifier. The transaction is then made using the opaque transactional identifier.

This invention relates to the domain of telecommunications and the management of multimedia services. This invention more particularly relates to a method for checking the complete delivery of a service supplied through a set of “enabler” servers and managing an opaque user identifier.

Throughout the following, any server element capable of providing a service will be called an “enabler” or “service enabler”. The following describes the definitions of technical terms used throughout this presentation:

Commit: action on a transaction to change its state to permanently validated

Rollback: action on a failed transaction to notify that this current transaction has been abandoned and to put the system back to its initial state.

Begin: action marking the beginning of a transaction

Timeout: end of a timeout

Mask: mask

Unmask: unmask

Start: start

Completed: notify correct completion

Error: notify an error

Update: update

OpenTransaction: open the transaction

CloseTransaction: close the transaction.

Identifier managers (GID) are known in prior art in the form of computer systems provided with interfaces for masking and unmasking the identity of a user by means of an opaque identifier. This type of GID manager provides external systems with a means of communicating with a user without divulging its identity. GID identifier managers are installed to satisfy legal constraints intended to guarantee confidentiality of some information. However, GIDs are not suitable for managing session or transaction concepts related to a service and a user or a given user group.

Dialog managers (GD) are also known that are composed of a computer system nested in a services invoicing management system. Dialog managers GD provide firstly a dialog with the user to inform him about the price of a service and to obtain his confirmation, and secondly to trigger invoicing at the end of the service. The dialog manager GD is exclusively designed to solve invoicing problems and usage of a manager GD is technologically dependent on the server element capable of creating and providing “enabler” services.

Offer managers (GO) also exist to check that the service offer is being executed correctly. Most GOs are technically dependent on the server element capable of creating and providing “enabler” services. Therefore, they frequently apply to a “single server element” service or even a single request service. Therefore, they are incapable of correctly handling an end to end “multi server element” service.

“Framework” service development software platforms are also known that usually provide partners with control access to the operators network resources. These partners may be Value Added Service Providers (VASP). OSA (Open Service Architecture) or PARLAY platforms are examples of such “framework” platforms. OSA can thus define an interface with a mobile radiotelephony network that offers standard capacities. PARLAY is comparable to OSA but for the fixed telephony network. This type of service development platform operates:

either in proxy mode, which obliges VASP (value added service provider) partners to technically integrate the “framework” software platform, and the “framework” software platform has to be updated to include new “enabler” server elements in it capable of creating and supplying services or simply new interfaces on server elements capable of creating and providing “existing” services.

or in “directory” mode, which means that no further statistical information can pass through the server element capable of creating and supplying “enabler” services on the “framework” software platform, once the reference has been allocated to it.

Therefore, at the moment there is no solution that could enable management of a service session for a subscriber that uses several “enabler” server elements on the telecommunication operator's network. It is then not possible to generate events when execution of the service is complete (or incomplete).

One purpose of this invention is to eliminate these disadvantages according to prior art. Thus, the invention described in this document provides a solution for addressing the following problems:

provide an assurance that a service is correctly delivered using “enabler” server elements of an operator network,

guarantee the end-to-end QoS (Quality of Service)

control access to “enabler” server elements for a given user and service

obtain statistical information about the use and execution of a service both in Pull/MO (Mobile Originated) mode originating from a request from the mobile, and in Push/MT (Mobile Terminated) mode originating from a request by a server element to be sent to a mobile,

management of opaque identifiers that enables the operator to guarantee user confidentiality with regard to service providers.

To this end, the present invention relates to a control process with management of an opaque user identifier for the complete delivery of a service using at least one server, characterised in that it is done by a transactional identifier server means storing a description of a plurality of service offers taken out by the user from value added service providers , in a memory for each user, the said transactional identifier server means comprising a management module used to associate an opaque transactional identifier with a user or user group and at least one determined service, the process comprising the following steps:

an “enabler” server element that intercepted a service request from a user, or one of the said service providers sending an open transaction request of at least one service calling at least one determined “enabler” server element executing sub-transactions, this request being described sequentially with a batch of open primitives sent to a communication interface of the transactional identifier server means (GIDT) and notifying a user identification (Userld),

analysis of the request and generation of an opaque transactional identifier (trld) by management and control means of the transactional identifier server (GIDT), then,

an execution step of the transaction using the opaque transactional identifier (trld).

Therefore, the invention provides access to a service offer while guaranteeing user confidentiality with regard to service providers, by using an opaque session identifier for an authorised user.

According to another particular feature of the invention, the analysis step comprises a check by the management module of the correspondence of determined “enabler” server elements with a listed service offer accessible for the user among the plurality of service offers and a check on the authorization to open the transaction by control means of the transactional identifier server means (GIDT) for the service supplied by the “enabler” server elements (LOC, SMS, MMS) and the specified user, particularly as a function of the user identification (Userld).

According to another particular feature of the invention, the execution step of the transaction is initiated by a value added service provider having received the opaque transactional identifier from the transactional identifier server means, the service provider making a request to a determined enabler server element with the opaque transactional identifier as a parameter, for a determined service forming a sub-transaction, to trigger sending an unmask request to the transactional identifier server, in response on the determined enabler server element, to enable the supply of a non-opaque identification number corresponding to the opaque transactional identifier starting from the opaque identifier, followed by a check carried out by the check means of the transactional identifier server means to check if the determined “enabler” server element is or is not authorized for this service and for this user, such that if it is authorized, the non-opaque identification number is transmitted through a communication interface called the enabler interface to the determined server element to enable execution of the sub-transaction.

According to another particular feature of the invention, the transactional identifier composed of not more than 15 digits, is conform with the UIT-T E-164 numbering plan and the non-opaque identification number is the MSISDN number.

According to another particular feature of the invention, the transactional identifier server means comprises firstly a transactional motor generating emissions of transactional events composed of one of the BEGIN, COMMIT, ROLLBACK commands and secondly a traceability motor recording each event from the transactional motor and all information transmitted during use of the transactional identifier server means in the memory.

According to another particular feature of the invention, the opaque transactional identifier is sent to the service offer supplier after memorisation of a transactional context in a memory of the transactional identifier server means, indicating particularly:

a user identification number;

the transactional identifier;

the offer associated with the transaction;

the state of progress of the transaction for the offer associated with it.

According to another particular feature of the invention, the opaque transactional identifier is sent to the service offer provider only after a transactional event has been generated representing the start of a transaction to at least one external system, through a second communication interface of the identifier server means called the transaction notification interface.

According to another particular feature of the invention, a transactional event representing the start of a transaction to at least one external system is generated by a BEGIN command generated by a transactional motor of the transactional identifier server means.

According to another particular feature of the invention, the transactional identifier server means transmits data representing whether or not the offer is complete from the transaction notification interface to at least one external system, using a COMMIT command generated by the transactional motor to inform the external system for example invoicing system, that the transaction is completely finished.

According to another particular feature of the invention, the transactional identifier server means sends an end of ROLLBACK transactional event through the transaction notification interface to notify at least one external system that the number of transaction rollbacks on error has been exceeded, and that the transaction is cancelled to provide data to a dialog manager and to decide whether or not to invoice this service.

According to another particular feature of the invention, the management and control means of the transactional identifier server perform the analysis of the open transaction request, particularly by solving correspondence between a technical service address notified in the open transaction request and a listed service offer listed among the various service offer descriptions stored in the memory of the transactional identifier server means.

According to another particular feature of the invention, the memory of the transactional identifier server means stores service offer descriptions validated by the said suppliers, input through a third communication interface called the service description supply interface.

According to another particular feature of the invention, the description of a service offer comprises data formulated in a meta language or an equivalent form enabling the control means of the identifier server means to check if the service is being executed correctly and to detect the start and the end.

According to another particular feature of the invention, the transactional identifier server means comprises an additional communication interface for use by value added service providers, the first interface being for use by server elements.

According to another particular feature of the invention, the transactional identifier server means comprises internal logic performing the following methods: Start, Completed, Error, Mask, Unmask, Update, Open Transaction, Close Transaction.

According to another particular feature of the invention, the Start method of the transactional identifier server means generates a transactional identifier, creates a transactional context in memory, generates a BEGIN type transactional event and returns the transactional identifier to the service offer supplier.

According to another particular feature of the invention, the Completed method of the transactional identifier server means carries out a test to determine if a sub-transaction of the transaction has been executed, modifies the transactional context accordingly, scans the description of the offer to determine if it is necessary for the transactional identifier server means to wait for an external event, sets the logic either waiting for a timeout, or a Close transaction, checks if the transaction is complete and generates a COMMIT type transactional event.

According to another particular feature of the invention, the Error method of the transactional identifier server means checks if the number of transaction rollbacks on error has been exceeded and if it has, generates a ROLLBACK type transactional event.

According to another particular feature of the invention, the Mask method is sent by an “enabler” server element to find information for the targeted offer starting from the technical address and the plurality of service offers, to control access of a user subscribing to the service offer and to send either an access refusal or trigger the Start method.

According to another particular feature of the invention, the Unmask method is sent by an “enabler” server element to find information for the targeted offer starting from data representing the technical address and the transactional identifier, and starting from the said plurality of offers, to control access of a partner provider to the “enabler” server element, to check that the request made to the server element corresponds to the current context of the transaction, and to notify the server element that the transactional identifier server means is waiting for an update, return the MSISDN number associated with the opaque transactional identifier, start waiting for the update, then check that the received update contains the information necessary to execute the offer, to either send a Completed method or an Error method.

According to another particular feature of the invention, the Update method is sent by an “enabler” server element and consists of putting into the waiting state for an update concerning execution of the request by the transactional identifier server.

According to another particular feature of the invention, the Open Transaction method is sent by a value added service supplier to control access of a partner to one of the operator's subscribers and to generate either an access refusal or to trigger a Start method.

According to another particular feature of the invention, the Close Transaction method is sent by a value added service provider and generates an event capable of unblocking the timeout of the logic of the transactional identifier server means.

The invention and its characteristics and advantages will become clearer after reading the description with reference to the attached drawings given as non-limitative examples, among which:

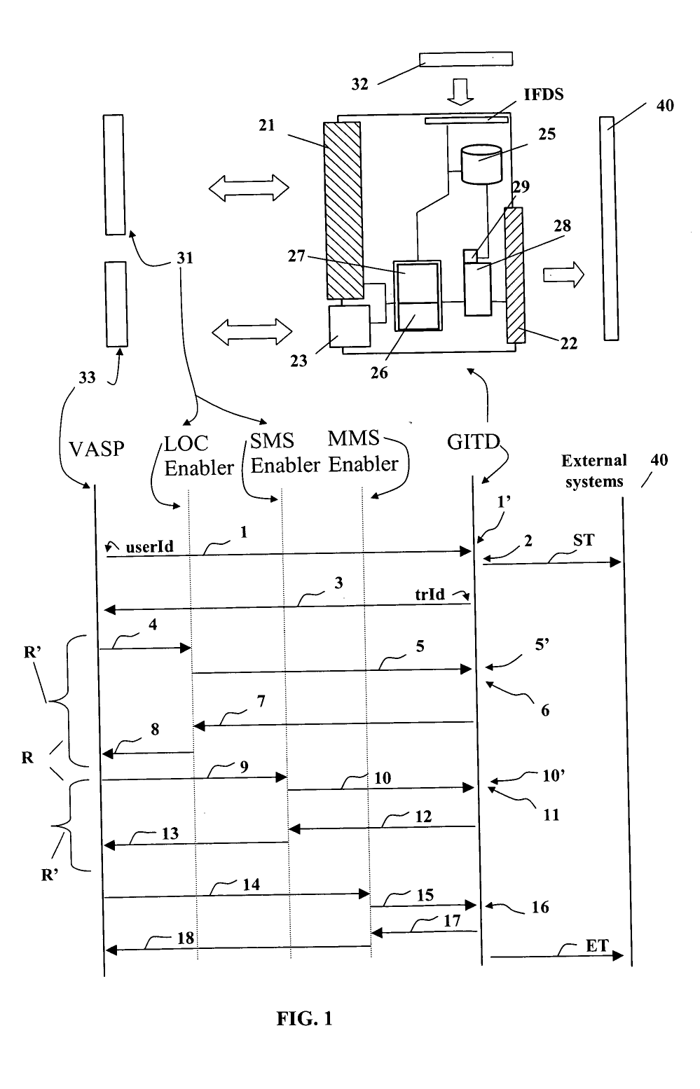

FIG. 1 diagrammatically shows an example of a process used in the invention, in one variant in Push/MT mode,

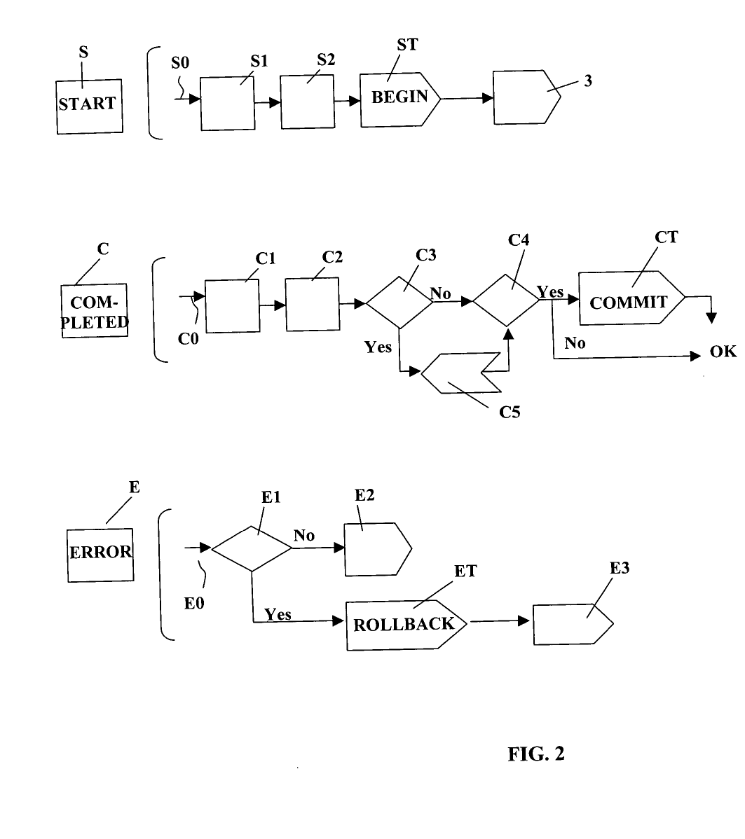

FIG. 2 shows three logic elements used by the server identifier means,

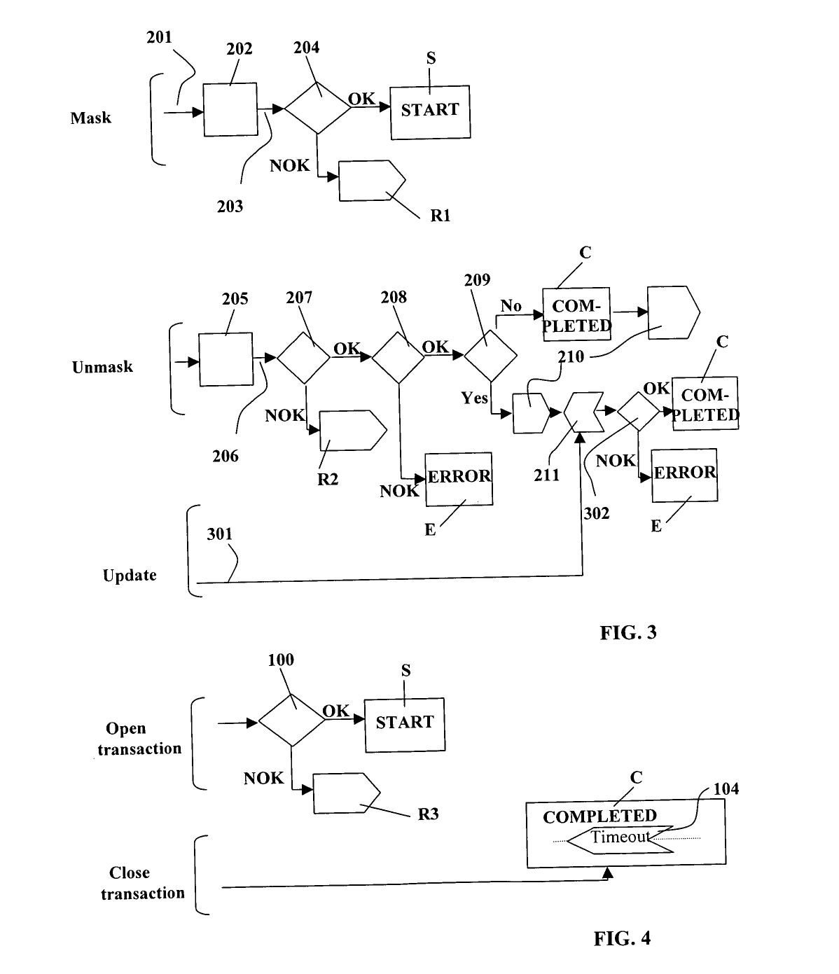

FIG. 3 shows diagrams of state logic associated with interactions between “enabler” server elements of the network and the identifier server means,

FIG. 4 shows an example of state logic associated with interactions between value added service providers and the identifier server means,

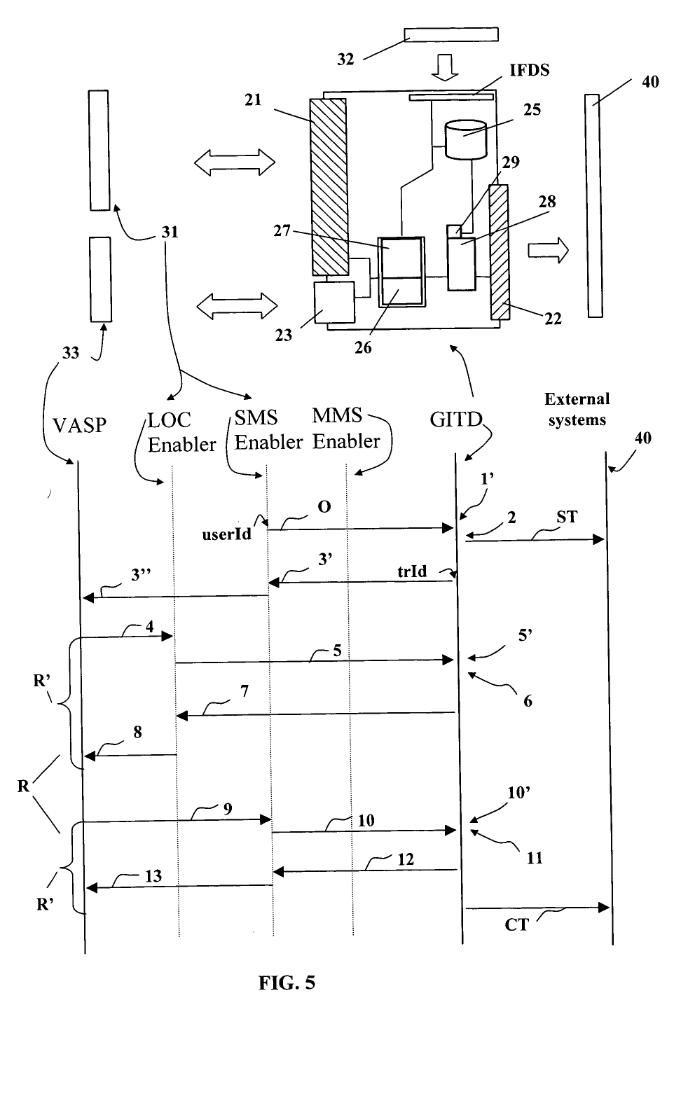

FIG. 5 diagrammatically shows an example process used in the invention, in one variant in Pull/MO mode. Furthermore, the appendix contains abbreviations used in this application.

We will now describe the invention with reference to FIGS. 1 and 2.

The process according to the invention is made by means of a transactional identifier server that will be called a transactional identifier manager (GIDT) in the remainder of this presentation. This identifier server means (GIDT) enables association of an identification element (Userld) corresponding to a user (or a user group) for a transaction or a sub-transaction on a given service. This transactional identifier (trld) is used in substitution of the MS-ISDN (Mobile Station—Integrated Services Digital Network) number in the communication with partner service providers (33) such as VASP, application suppliers and specialised gateways or other partners, and has the characteristic of complying with the recommendation of a standard numbering plan, for example UIT—TE.164 which imposes a sequence of not more than 15 digits, and part of this information can be used to identify the operator capable of interpreting this transactional identifier (trld). The transactional identifier manager (GIDT) comprises a fist communication interface (21) to enable data transmission with servers or enablers (31). This manager (GIDT) also comprises a second communication interface (22) called the transaction notification interface, enabling generation of transactional events representing a transaction start (ST), end (CT) or cancellation (ET) to any external system (40). For example, this interface (22) connects the manager (GIDT) to one or several external invoicing systems (40) and/or to a dialog manager.

As shown in FIG. 1, the transactional identifier manager (GIDT) comprises a management module (27) for associating a so-called transactional identifier (trld) with a user or user group and with at least one determined service. For example, the manager (GIDT) can manage the subscription of users to service offers with service providers (33). As a variant, the transactional identifier manager (GIDT) can also connect to a subscription manager. The memory (25) of the manager (GIDT) can in particular memorise descriptions of service offers validated by suppliers (31) and store a plurality of transactional contexts related to a user or user group for a service. In particular, each transactional context indicates the user's identification number (Userld), the transactional identifier (trld), the offer associated with the transaction and the state of progress of the transaction. This state of progress may for example be described by the number of completed sub-transactions (R′), and the number sub-transactions (R′) remaining to be executed.

Service offer descriptions may be input by a procurement system (32) with a third communication interface called the supply of service descriptions interface (IFDS).

As shown in FIG. 1, the transaction identifier manager (GIDT) can locate itself at the heart of a software platform, capable of:

managing transactional identifiers (trld),

managing statistical information about accesses to unmasking requests from network enablers (31),

store a service representation, and more particularly its sequence/execution,

check execution of a service and therefore check that it is done end to end,

send transactional triggers, for example BEGIN (ST) to begin, COMMIT (CT) to execute, and ROLLBACK (ET) to cancel (FIG. 2).

To successfully manage transactional identifiers (trld), the management module (27) is connected to the memory (25) and to the service description supply interface (IFDS). In one embodiment of the invention, the memory (25) of the transactional identifier manager (GIDT) stores descriptions of service offers transmitted by the procurement system (32) with descriptions of services that use the supply interface (IFDS). This procurement system (32) taken into account by partner providers (33) supplies a complete description of a service. In one embodiment of the invention, the memory (25) stores descriptions containing details of services, particularly the method of communication with the different enablers (LOC, SMS, MMS) that form part of the offer. This description could for example be defined from a meta language, Regular Expression, XML Scheme or DTD, or in any other form enabling the transactional identifier manager (GIDT) to check that a service is being correctly executed and to detect the beginning and the end. Partner providers (33) are familiar with the method used to describe their service, such that an offer corresponding to the expected description, including one or several services, can actually be provided.

For example, the service description for a service offer involving a localisation enabler (LOC), a short message enabler (SMS) and a multimedia message enabler (MMS), can be in the following form: “(SMS_MO, LOC, MMS)”, in other words the complete service must be composed of an SMS_MO, a localisation request and sending a multimedia message. In another example, the description can be formulated as “(LOC, WAP-PUSH+, [Close-transaction/timeout (2 days)])”, which means that the service must be composed of a localisation request, followed by a 1 to n WAP push. The end of service is triggered either by a timeout, or by a close transaction order produced by an enabler server (31) or the service provider (33).

The service description can also contain details of the contents of each request to an enabler server element (31), for example such as “(SMS_MO:‘“JOKE*’,MMS)” to signify that the service must be composed of an SMS_MO beginning with JOKE and a multimedia message. In one variant embodiment of the invention, the service description may possibly include transactional sub-parts, for example that could be defined as being nested. Thus, the import or reference mechanisms can be used in the case of an XML description. In this case, completion of a service may depend on the execution of transactional sub-parts. These transactional sub-parts may possibly be invoiced separately by an external invoicing system (40). Enabler servers (LOC, SMS, MMS) in FIG. 1 are shown only as an example. Any other enabler server element such as CAMEL, WAP-server, etc. could be used in the process implemented with the transactional identifier manager (GIDT).

In one embodiment of the invention, the transactional identifier server means (GIDT) comprises an additional communication interface (23) intended for use by value added service providers (33) or equivalent, the first interface (21) being intended for use by network server elements (LOC, SMS, MMS). This additional interface (23) enables a partner provider (33) to open a transaction for a given user on a service type. This interface (23) is only necessary in the case in which a service provider (33) initiates the service to the subscriber, in other words in PUSH mode, for example as in the embodiment in FIG. 1. In the case of an open service description, the VASP or similar type of partner provider (33) can use a method by which he can notify that, as far as he is concerned, the service is complete. Moreover, since this additional interface (23) is optional, in most cases the manager (GIDT) forms a transparent component for VASP partners or similar partners.

We will now describe the invention with reference to FIG. 2.

FIG. 2 shows three logic elements in the internal logic used by the management module (27), to manage complete delivery of the service using an opaque user transactional identifier (trld), using the process according to the invention. The commonly called START (S) method is one of the three methods used by this internal logic, and it executes the following operations in sequence, after previously retrieving (S0) the identification number (Userld) MSISDN:

generation (S1) of a transactional identifier using the data supplied, including particularly the MSISDN number,

creation (S2) of a transactional context including the identification number (Userld) MSISDN, the transactional identifier (trld), the offer associated with the transaction and the state of progress of the transaction,

storage of the transaction context in the memory (25) of the manager (GIDT),

generation of a BEGIN (ST) transactional event sent to external systems (40) to notify the beginning of the transaction, then

the transactional identifier manager (GIDT) sends (3) the transaction identifier (trld) corresponding to the service, to the service provider (31).

The commonly called Completed (C) method used by the transactional identifier server means (GIDT) makes a test (C1) to determine whether or not a sub-transaction of the transaction has been done completely (C0), and then modifies (C2) the transactional context accordingly. The Completed method (C) also scans the description of the offer (C3) to determine whether or not it is necessary for the transactional identifier server means (GIDT) to wait (C5) for an external event, sets the logic either as waiting for a timeout, or for a Close transaction. Finally, this method checks (C4) whether or not the transaction is complete and generates a COMMIT (CT) type transactional event. It can be understood that the logic element corresponding to the COMPLETED (C) method can be used to check progress with the transaction. Several sub-transactions (R′) can be carried out in sequence within a same transaction using this method. Thus, in the embodiment shown in FIG. 2, the COMPLETED (C) method includes the following operations:

possibly a test to check (C1) end of execution (CO) of a sub-transaction (R′) and modification (C2) to the state of progress of the transaction memorised in the transactional context, integrating the completed sub-transaction (R′),

scanning of the description of the offer (C3) to determine whether or not it is necessary for the manager (GIDT) to wait for an external event,

in a first case, to set the logic in waiting (C5) for an event, this waiting terminating after a timeout, or a Close transaction, otherwise if no particular event is expected, check (C4) the state of progress of the transaction, then

generate a COMMIT (CT) transactional event sent to external systems (40) to notify the end of the sub-transaction.

The transactional identifier manager (GIDT) can transmit data representing the complete execution of a service from the transaction notification interface (22) to any external system (40), using the COMMIT (CT) command generated by the transactional motor (28) to inform the external system (40), for example an invoicing system, that the transaction has been completely executed. The manager (GIDT) also memorises this change in the transactional context, in the memory (25). In particular, the check step (C4) identifies the difference between the end of the final sub-transaction (R′) and the end of an intermediate sub-transaction (R′). Thus, the state of progress of the transaction execution can be determined.

The internal logic of the transactional identifier server means (GIDT) also uses a method commonly called ERROR (E) that is capable of detecting and signalling the presence of an error with an incidence in the process according to the invention. An error code (E0) is received by a comparator means that checks the number of restarts on error. The comparison (E1) is made between the number of restarts on error and a predetermined threshold. Until the threshold has been reached, the error is discarded (E2) and does not have any consequence on the transactional context. Otherwise, a ROLLBACK transactional event (ET) is sent to external systems (40) to cancel the transactional context. In one embodiment of the invention, the transactional identifier (trld) is immediately deleted.

We will now describe the invention with reference to FIGS. 1, 2 and 3.

The first communication interface (21) initialises a transaction for a service and a given user. It also provides access to the unmask request (5, 10) for the transactional identifier (trld) initiated by an enabler element (31). This request (5, 10) usually provides access to the identification number (Userld) for example including the MSISDN number. An update service request (301) can also be addressed to this interface (21). As shown in FIG. 3, the update request (301) may be associated with actual execution of the enabler request (LOC, SMS, MMS), as far as the user subscribing to the service offer, in order to make sure that the service has been correctly delivered. For example, the Update request may also be associated with the contents of the information that passes through the enabler element (31) to the subscriber, to check the content of the service.

In one embodiment of the invention, the update method is sent by an enabler server element (31). It is composed of the waiting for update status concerning execution of the request from the transaction identifier server (GIDT). The update may be made asynchronously with execution of the request to an enabler element (31) but it can influence the transactional COMMIT (CT) of all or part of the service offer. For example, in the case of a short messages enabler (SMS), asynchronous delivery notification messages can be used to make sure that the content has been delivered to the user.

The process according to the invention can function equally well in Push/MT mode and in Pull/MO mode, sending an open transaction request (1) for at least one determined service can be initiated either by a user or by a service provider (33). In the example in FIG. 1, the provider (33) requests that the manager (GIDT) should open a transaction on behalf of a user represented in the request by a telephone number type identifier (Userld) of any other user identifier. This request (1) is addressed in Push mode to the first communication interface (21) of the manager (GIDT). This manager then analyses (1′) the request (1) using the management and control means (26, 27) of the manager (GIDT), to check that the service according to the request corresponds to a listed service offer included in the various service offers stored in memory (25). These management and control means (26, 27) perform the analysis (1′) particularly by determining a correspondence between a technical service address notified in the open transaction request (1) and a service offer listed among the various service offer descriptions stored in the memory (25) of the identifier server means (GIDT). In the embodiment in FIG. 1, a technical address is inserted in the open transaction request (1) to describe the service supplied by the supplier (31) who originally made the request (1). This technical address is “solved” by the manager (GIDT) and this manager associates this technical address with a transactional identifier (trld).

In one embodiment of the invention, the analysis step (1′) comprises a check made by the management module (27) on the correspondence of “enabler” server elements (31) denoted in the technical address with a listed service offer accessible to the user among the various service offers and a check on authorisation to open the transaction by control means (26) of the transactional identifier server means (GIDT) for the service provided by the “enabler” server elements (31) and the specified user, particularly as a function of the user identification (Userid). The transaction execution step (R) using the opaque transactional identifier (trld) follows the analysis step (1′) of the request (1).

In the embodiment shown in FIG. 1, the open transaction request (1) sent by the service provider (33) applies to a service calling three “enabler” server elements (LOC, SMS, MMS) making sub-transactions (R′). This request (1), addressed to the communication interface (23) with transactional identifier manager (GIDT) suppliers, can be described sequentially with a batch of open primitives and notifies a user identification (Userld). In another embodiment of the invention, the request (1) may relate to at least one service calling one or several “enabler” server elements (31).

The execution step (R) of the transaction is initiated by the service provider (33) after reception of the opaque transactional identifier (trld). The service provider (33) makes a request to one determined server (LOC, SMS, MMS) among the enabler server elements (31), with the opaque transaction identifier (trld) as a parameter, and a determined service forming a sub-transaction (R′) as shown in FIG. 1. In response to this request, the determined enabler server element (LOC, SMS, MMS) sends an unmask request (5, 10) to the transactional identifier manager (GIDT) to authorise supply of a non-opaque identification number (Userld) corresponding to the opaque transactional identifier (trld), from the opaque identifier (trld). The checking means (26) of the transactional identifier server means (GIDT) then make a check (5′, 10′) to verify whether or not the determined “enabler” server element (LOC, SMS, MMS) is authorised for this service and for this user, such that if an authorisation is given, the non opaque identification number (Userld) is sent (7, 12) through the first communication interface (21) to the determined server element (LOC, SMS, MMS) to enable the sub-transaction (R′) to be executed.

In the example in FIG. 1, the first sub-transaction (R′) relates to a localisation service involving a localisation server (LOC). This first sub-transaction (R′) begins with a localisation request (4) made by the service provider (33) and addressed to the localisation server (LOC) with the transaction identifier (trld) as a parameter. After receiving the non-opaque identification number (Userid) transmitted (7) by the manager (GIDT), the localisation server (LOC) transmits (8) the requested localisation information to the service offer provider (31).

In the preferred embodiment of the invention, the transactional identifier manager (GIDT) comprises firstly a transaction motor (28) generating transmissions of transactional events composed of one of the BEGIN (ST), COMMIT (CT), ROLLBACK (ET) commands and secondly a traceability motor (29) that writes each event from the transactional motor (28) and information sent while the transactional identifier manager (GIDT) is being used, into the memory (25). As shown in FIG. 1, the analysis step (1′) with the authorisation check for opening the transaction, is immediately followed by sending a start transaction event to at least one external system (40), in the form of a BEGIN (ST) command generated by the transactional motor (28). The start transaction event is generated through the transaction notification interface (22) of the manager (GIDT).

The external system (40) may consist of an invoicing system, for example to reserve an invoicing ticket. The analysis step (1′) is also followed by a record by the traceability motor (29) of open service statistics, carried out at approximately the same time as the BEGIN command (ST) is generated. As soon as the start transaction event has been sent to the external system (40), a sub-transaction (R′) can be done. The traceability motor (29) also records statistics (6, 11) at the end of each sub-transaction (R′). The transactional context is updated at the end of execution of a sub-transaction (R′). Naturally, dialog manager type systems (MMI), payment systems per action or by fixed fee and other similar systems can be added to the transactional motor (28). In one embodiment of the invention, the traceability motor (29) uses all information transmitted about use of the transactional identifier manager (GIDT) for example on the access control (either positive or negative), on execution of the offer regardless of whether it is complete or in progress, etc.

In the example in FIG. 1, the second sub-transaction (R′) uses a short message server (SMS), the service provider (33) making a request to the server (SMS). The communication mode is similar to the case mentioned above for the sub-transaction (R′), with the localisation server (LOC). This time, after the server (SMS) has received the non-opaque identification number (Userld) (12) sent by the manager (GIDT), it transmits (13) the requested short message information to the service provider (33). A third sub-transaction uses a multimedia message enabler server (MMS). In the example of this third sub-transaction, the manager (GIDT) detects an inconsistency between the service description stored in memory (25) and the request to call the multimedia message enabler server (MMS). For example, this type of error may be detected when the service description includes sending an e-mail. The first two steps (14, 15) are similar to the first two steps (4, 5) of the first sub-transaction (R′) concerning the localisation server (LOC). The inconsistency is then detected when the unmasking method is executed, as shown on the corresponding diagram in FIG. 3. The traceability motor (29) records statistical information (16) representing failure of the transaction. The transactional identifier manager (GIDT) then sends a negative response (17) to the enabler server element (MMS) through the first communication interface (21). This enabler server element (MMS) notifies the service offer provider (31) that the authorisation (18) to send the short multimedia message was refused. Finally, the transactional identifier manager (GIDT) transmits an end of ROLLBACK (ET) type transactional event through the transactions notification interface (22) to inform the external system (40) that the end-to-end service has failed, the number of rollbacks of the transaction due to error being exceeded. This ROLLBACK event (ET) notifies that the transaction has been cancelled. In one embodiment of the invention, data supplied with the ROLLBACK transactional event (ET) are transmitted to a dialog manager and are used to decide whether or not to invoice the service.

We will now describe the invention with reference to FIGS. 3 and 4.

FIG. 3 shows state logic methods associated with interactions between the enabler server elements (31) and the manager (GIDT). The so-called masking method Mask of the transactional identifier manager (GIDT) executes a first step (202) to find information for the targeted offer (203) for the user (Userld) starting from the technical address (201) and the plurality of service offers stored in the memory (25). The Mask method then checks access (204) of a user subscribing to the service offer (203) and sends either an access refusal (R1) or triggers the Start method (S).

The so-called Unmask method of the transactional identifier manager (GIDT) executes a first step (205) to find information for the targeted offer (206) starting from data representing the technical address and the transactional identifier (GIDT) and starting from the said plurality of offers. Then, as shown in FIG. 3, the Unmask method checks access (207) of a partner (33) to the enabler server element (LOC, SMS, MMS) and checks (208) that the request made to the server element (LOC, SMS, MMS) corresponds to the current context of the transaction. Then, if an update is necessary, the Unmask method continues by informing the enabler server element (LOC, SMS, MMS) that the transactional identifier manager (GIDT) is waiting for an update, returns (210) the MSISDN number or similar identification (Userld) associated with the opaque transactional identifier (trld), starts waiting (211) for the update, and then checks (302) that the received update contains the information necessary to execute the offer, to either send a Completed method (C) or an Error method (E). An access refusal (R2) is notified when the access has not been authorized during the check (207). In the embodiment shown in FIG. 3, a check step (209) on the update takes place after the verification step (208) to directly activate execution of the offer using a Completed method (C) if the update is not necessary.

FIG. 4 shows methods of communication between a service provider (33) and the transactional identifier manager (GIDT) used to open and close a transaction. The OpenTransaction method is sent by a value added service provider (33) to the suppliers' interface (23) of the manager (GIDT) to control access (100) of a partner (33) to a subscriber of the operator and to produce either 30 an access refusal (R3) or to trigger a Start method (S). The CloseTransaction method sent by a provider (33) to the interface for suppliers (23) of the manager (GIDT) generates an event to release the timeout of the logic of the transactional identifier manager (GIDT).

We will now describe the invention with reference to FIG. 5.

In Pull/MO mode, the delivery dynamics of a service is quite different from operation in Push mode. FIG. 5 illustrates the case of a service described in the memory (25) as being composed of a localisation request followed by sending a short message SMS. As for Push mode, execution of the service, particularly calls enablers, is recorded in the description of the service and the technical address of the service offer provider (31) is known to the manager (GIDT).

Firstly, a service request from a user must be sent to an enabler server element for messages (SMS) through an MO message sent from the user's mobile telephone. The enabler server element (SMS) then intercepts the service request sent by the user. Since the general ledger of the enabler (SMS) is associated with a technical address of the service, the enabler (SMS) requests the transactional identifier manager (GIDT) to open a transaction for the user and the service concerned. This open request (O) addressed to the first communication interface (21) of the manager (GIDT) is described sequentially with a batch of open primitives and notifies a user identification (Usernd). An analysis (1′) of the request (O) is then made and if the control means (26) of the manager (GIDT) issue an authorisation, a BEGIN (ST) command will be generated by the transactional motor (28) to notify the external system (40) about a start transaction event.

A transaction identifier (trld) corresponding to the service and to the user is returned (3′) to the general ledger enabler of short messages (SMS). The value added service provider (33) then receives (3″) the user request in the form of a short message sent from the enabler (SMS) but without knowing the exact identity of the enabler since it is only provided with the transactional identifier (trld). Sub-transactions (R′) can then be carried out in the same way as in communication mode in Push mode (FIG. 1). At the end of the last sub-transaction (R′), the transactional identifier manager (GIDT) detects that the transaction has been correctly executed (R) for the service. It notifies the external system (40) that the service has been delivered from end-to-end for the user concerned, by generating a COMMIT (CT) transactional event.

One of the advantages of the process according to the invention is that it can be used to manage a service session to a subscriber using several enablers in the operator's network, by generating events on progress with its execution, which for example enables invoicing a service as a function of the number of sub-transactions actually carried out.

Another advantage of the invention compared with existing techniques is that the operator can guarantee confidentiality of user data with respect to service providers.

Persons skilled in the art will be fully aware that this invention can be used with different embodiments in many other specific forms without going outside the scope of the invention as claimed. Consequently, these embodiments should be considered as being provided for illustrative purposes only, but they can be modified within the extent of the scope of the attached claims, and the invention must not be limited to the details given above.

### Appendix

Technical address: character string describing a given service for an enabler. A technical address may be a short message or a short code in the case of SMS and GD media (for example “2222”) or a URL address in the case of Wap media (for example http://wap.sfr.net). The character string making up the technical address can also be terminated with the * character.

CAMEL: Customized Applications for Mobile network Enhanced Logic (generic name of applications for mobiles)

DTD: Document Type Definition

GD: Dialog Manager

GID: Identifier Manager

GIDT: Transactional Identifier Manager

GO: Offer Manager

LOC enabler Localisation platform

SMS enabler: Platform used to send short messages

MMS enabler: Platform used to send multimedia messages

MMI: Man-Machine Interface

MO/MT: Mobile Originated/Mobile Terminated

MS-ISDN: Mobile Station—Integrated Services Digital network. This is the call number of the mobile telephone

OSA: Open Service Access (defines an interface with a mobile radiotelephony network)

PARLAY: equivalent of OSA for the fixed network

UIT: Union Internationale des Telecommunications

VASP: Value Added Service Provider

WAP: Wireless Application Protocol

WAP-server: WAP server that can be used by mobile telephones through a WAP gateway translating information transmitted on a mobile network into a format compatible with Internet, and that is capable of making the inverse conversion.

XML: eXtensible Mark-up Language. Meta language similar to HTML.

1. Control process with management of an opaque user identifier for the complete delivery of a service using at least one server, characterised in that it is done by a transactional identifier server means storing a description of a plurality of service offers taken out by the user from value added service providers, in a memory for each user, the said transactional identifier server means comprising a management module used to associate an opaque transactional identifier with a user or user group and at least one determined service, the process comprising the following steps:
an “enabler” server element that intercepted a service request from a user, or one of the said service providers sending an open transaction request of at least one service calling at least one determined “enabler” server element executing sub-transactions, this request being described sequentially with a batch of open primitives sent to a communication interface of the transactional identifier server means and notifying a user identification,
analysis of the request and generation of an opaque transactional identifier by management and control means of the transactional identifier server, then,
an execution step of the transaction using the opaque transactional identifier.

2. Process according to claim 1, characterised in that the analysis step comprises a check by the management module of the correspondence of determined “enabler” server elements with a listed service offer accessible for the user among the plurality of service offers and a check on the authorization to open the transaction by control means of the transactional identifier server means for the service supplied by the “enabler” server elements and the specified user, particularly as a function of the user identification.

3. Process according to claim 1, characterised in that the execution step of the transaction is initiated by a value added service provider having received the opaque transactional identifier from the transactional identifier server means, the service provider making a request to a determined enabler server element with the opaque transactional identifier as a parameter, for a determined service forming a sub-transaction, to trigger sending an unmask request to the transactional identifier server, in response on the determined enabler server element, to enable the supply of a non-opaque identification number corresponding to the opaque transactional identifier starting from the opaque identifier, followed by a check carried out by the check means of the transactional identifier server means to check if the determined “enabler” server element is or is not authorized for this service and for this user, such that if it is authorized, the non-opaque identification number is transmitted through a communication interface called the enabler interface to the determined server element to enable execution of the sub-transaction.

4. Process according to claim 1, characterised in that the transactional identifier composed of not more than 15 digits, is conform with the UIT-T E-164 numbering plan and the non-opaque identification number is the MSISDN number.

5. Process according to claim 1, in which the transactional identifier server means comprises firstly a transactional motor generating emissions of transactional events composed of one of the BEGIN, COMMIT, ROLLBACK commands and secondly a traceability motor recording each event from the transactional motor and all information transmitted during use of the transactional identifier server means in the memory.

6. Process according to claim 1, characterised in that the opaque transactional identifier is sent to the service offer supplier after memorisation of a transactional context in a memory of the transactional identifier server means, indicating particularly:
a user identification number;
the transactional identifier;
the offer associated with the transaction;
the state of progress of the transaction for the offer associated with it.

7. Process according to claim 6, in which the opaque transactional identifier is sent to the service offer provider only after a transactional event has been generated representing the start of a transaction to at least one external system, through a second communication interface of the identifier server means called the transaction notification interface.

8. Process according to claim 7, in which a transactional event representing the start of a transaction to at least one external system is generated by a BEGIN command generated by a transactional motor of the transactional identifier server means.

9. Process according to claim 7, in which the transactional identifier server means transmits data representing whether or not the offer is complete from the transaction notification interface to at least one external system, using a COMMIT command generated by the transactional motor to inform the external system for example invoicing system, that the transaction is completely finished.

10. Process according to claim 7, in which the transactional identifier server means sends an end of ROLLBACK transactional event through the transaction notification interface to notify at least one external system that the number of transaction rollbacks on error has been exceeded, and that the transaction is cancelled to provide data to a dialog manager and to decide whether or not to invoice this service.

11. Process according to claim 1, in which the management and control means of the transactional identifier server perform the analysis of the open transaction request, particularly by solving correspondence between a technical service address notified in the open transaction request and a listed service offer listed among the various service offer descriptions stored in the memory of the transactional identifier server means.

12. Process according to claim 1, in which the memory of the transactional identifier server means stores service offer descriptions validated by the said suppliers, input through a third communication interface called the service description supply interface.

13. Process according to claim 1, in which the description of a service offer comprises data formulated in a meta language or an equivalent form enabling the control means of the identifier server means to check if the service is being executed correctly and to detect the start and the end.

14. Process according to claim 1, in which the transactional identifier server means comprises an additional communication interface for use by value added service providers, the first interface being for use by server elements.

15. Process according to claim 1, in which the transactional identifier server means comprises internal logic performing the following methods: Start, Completed, Error, Mask, Unmask, Update, Open Transaction, Close Transaction.

16. Process according to claim 15, in which the Start method of the transactional identifier server means generates a transactional identifier, creates a transactional context in memory, generates a BEGIN type transactional event and returns the transactional identifier to the service offer supplier.

17. Process according to claim 15, in which the Completed method of the transactional identifier server means carries out a test to determine if a sub-transaction of the transaction has been executed, modifies the transactional context accordingly, scans the description of the offer to determine if it is necessary for the transactional identifier server means to wait for an external event, sets the logic either waiting for a timeout, or a Close transaction, checks if the transaction is complete and generates a COMMIT type transactional event.

18. Process according to claim 15, in which the Error method of the transactional identifier server means checks if the number of transaction rollbacks on error has been exceeded and if it has, generates a ROLLBACK type transactional event.

19. Process according to claim 15, in which the Mask method is sent by an “enabler” server element to find information for the targeted offer starting from the technical address and the plurality of service offers, to control access of a user subscribing to the service offer and to send either an access refusal or trigger the Start method.

20. Process according to claim 15, in which the Unmask method is sent by an “enabler” server element to find information for the targeted offer starting from data representing the technical address and the transactional identifier, and starting from the said plurality of offers, to control access of a partner provider to the “enabler” server element, to check that the request made to the server element corresponds to the current context of the transaction, and to notify the server element that the transactional identifier server means is waiting for an update, return the MSISDN number associated with the opaque transactional identifier, start waiting for the update, then check that the received update contains the information necessary to execute the offer, to either send a Completed method or an Error method.

21. Process according to claim 15, in which the Update method is sent by an “enabler” server element and consists of putting into the waiting state for an update concerning execution of the request by the transactional identifier server.

22. Process according to claim 15, in which the Open Transaction method is sent by a value added service supplier to control access of a partner to one of the operator's subscribers and to generate either an access refusal or to trigger a Start method.

23. Process according to claim 17, in which the Close Transaction method is sent by a value added service provider and generates an event capable of unblocking the timeout of the logic of the transactional identifier server means.
